(19) United States
(12) Patent Application Publication
(10) Pub. No.: US 2014/0054425 A1
(43) Pub. Date: Feb. 27, 2014

(54) ASSEMBLING CHANNEL OF SUPPORTING TOOL

(71) Applicant: Gyu Cheol Jang, Daegu (KR)

(72) Inventor: Gyu Cheol Jang, Daegu (KR)

(21) Appl. No.: 14/003,992

(22) PCT Filed: Mar. 8, 2012
(86) PCT No.: PCT/KR2012/001676

§ 371 Date: Nov. 4, 2013

(30) Foreign Application Priority Data
Mar. 8, 2011 (KR) 10-2011-0020278

(51) Int. Cl. F16L 3/00

(52) U.S. Cl. CPC F16L 3/00
USPC 248/49

(57) ABSTRACT

The present invention relates to an assembling channel of a supporting tool, including: a steel plate which is bent in three layers to configure a central supporting plate, and a wide-width supporting plate and a small-width plate configured at both sides of the central supporting plate; coupling holes formed on each of the supporting plates; cutting portions configured at equal interval on a bent portion, wherein the cutting portions located at both ends are always located toward the central supporting plate in opened states thereof such that firm assembly by using only bolts and nuts after overlapping connective parts without additional connective brackets during assembling of the supporting tool using the channels as well as rapid assembly of the supporting tool can be performed thereby.

### TECHNICAL FIELD

The present invention relates to an improvement of an assembling channel of a supporting tool, and more particularly, to an assembling channel of a supporting tool, which can be quickly and easily assembled and can be made firm, without additional subsidiary members, and can achieve simple assembly of various kinds of coupling parts such as clamps, hangers, and U-bands on the multi-purpose supporting tool assembled using the channel.

### BACKGROUND ART

Generally, various kinds of pipes (sanitary pipes, heat and cooling pipes, fire pipes, refrigerant pipes, and cooling water pipes) and cables are installed on ceilings or walls of various architectural structures or in underground utility tunnels in which electricity and communication facilities are installed. The pipes or the cables are supported by various types of supporting tools that are assembled using channels. In this case, various kinds of coupling parts such as clamps, hangers, and U-bands are used to tightly couple various pipes or cables to the supporting tool.

Also, various types of supporting tools assembled by channels are used for mechanical works or shelves on which various products are arrayed.

However, in the case of typical supporting tools, when supporting tools are assembled using channels, various types of brackets are located at connection sites and then these are assembled with bolts and nuts.

Accordingly, since various types of brackets are separately needed for the assembling of the supporting tools, costs involved in the manufacturing and purchase of brackets increase, and the assembling becomes inconvenient.

### SUMMARY OF INVENTION

### Technical Problem

The present invention has been made in an effort to solve the above problems, and is directed to assemble a supporting tool used for multi-purposes by using a channel, which can achieve a tighter assembly of the supporting tool by assembling channels by bolts and nuts, without brackets on connection sites of the channels, and simultaneously allowing the assembled channels to alternately overlap each other.

### Solution to Problem

According to the present invention, in order to solve the above problem, in configuring a channel for assembling a supporting tool, a wide-width supporting plate and a small-width supporting plate are configured on both sides of a central supporting plate by bending a steel plate in three layers. Coupling holes are punched in each supporting plate, to improve the assembling property of the channel, reduce the weight thereof, and improve the durability against warpage. Cutting portions are configured at equal intervals in the bent portion where the central supporting plate and the wide-width and small-width supporting plates contact each other. The cutting portion located at both ends in the cutting of the channel is always maintained toward the central supporting plate in an opened state. Therefore, if channels are connected for assembling the supporting tool, the small-width supporting plate configured at one channel is fitted into the cutting portion of the other channel. The wide-width supporting plate configured at one channel is located on top of the small-width supporting plate of the other channel. At the same time, the wide-width supporting plate of the other channel is located on the small-width supporting plate of one channel. In the above-described state, they can be tightly coupled and fixed by bolts and nuts through the coupling holes.

### Advantageous Effects of Invention

The assembling channel of the supporting tool of the present invention is configured. The steel plate is bent in three layers to configure the wide-width supporting plate and the small-width supporting plate on both sides of the central supporting plate. The coupling holes are punched in each supporting plate, and the cutting portions are configured in the cutting portion at equal intervals. The cutting portions located at both ends are always located in the central support plate side in the opened state. In assembling the support tool by using the channel, the connection sites are overlapped without additional brackets, and these are tightly assembled with only bolts and nuts. Moreover, the assembly of the support tool can be rapidly achieved.

### BRIEF DESCRIPTION OF DRAWINGS

FIG. 1 is a development view of a channel according to the present invention.

FIG. 2 is a perspective view of the channel according to the present invention.

FIG. 3 is a perspective view of the channel, when viewed from a different direction, according to the present invention.

FIG. 4 is a front view illustrating a configuration of the channel according to the present invention.

FIG. 5 is a cross-sectional illustrating a configuration of the channel according to the present invention.

FIG. 6 is a partially exploded perspective view of the channel according to the present invention.

FIG. 7 is a view illustrating an assembly state of the channel of FIG. 6.

FIG. 8 is a view illustrating another assembly state of the channel of FIG. 7.

FIG. 9 is an exemplary view of a supporting tool using the channel according to the present invention.

FIG. 10 is an exemplary view of a supporting tool using the channel according to the present invention.

FIG. 11 is an exemplary view of a supporting tool using the channel according to the present invention.

FIG. 12 is a view illustrating a channel reinforced with bolts and nuts to prevent deformation according to the present invention.

<Reference Numerals>

| | |
|---|---|
| 10: channel | 11: steel plate |
| 12, 12′: bent portion | 20: central supporting plate |
| 21: central surface coupling hole | 22: cutting portion |
| 23: cutting indicating portion | 24: rectangular indicating hole |
| 25: cutting hole | 28: central surface extension portion |
| 30: wide-width supporting plate | 31, 31′: wide-width surface coupling |
| | hole |
| 38: wide-width surface extension | |
| portion | |
| 40: small-width supporting plate | |
| 41: small-width surface | |
| coupling hole | |
| 48: small-width surface | |
| extension portion | |

### DESCRIPTION OF EMBODIMENTS

Hereinafter, exemplary embodiments of the present invention will be described in detail with reference to the accompanying drawings.

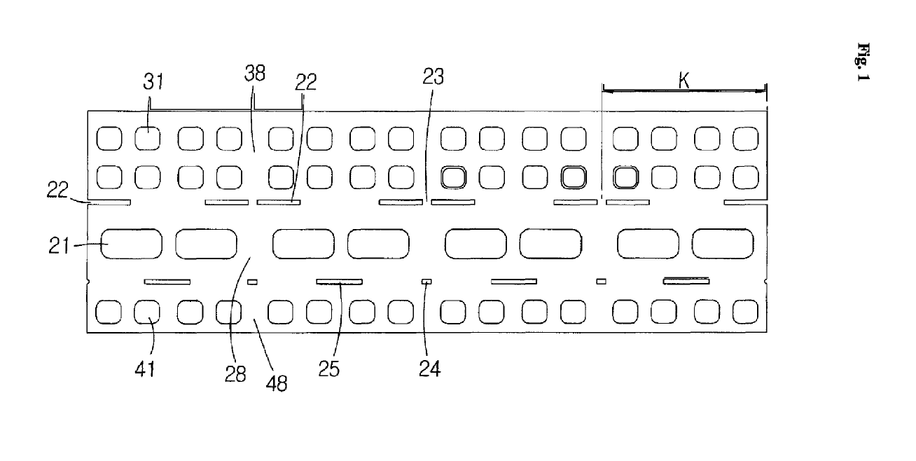

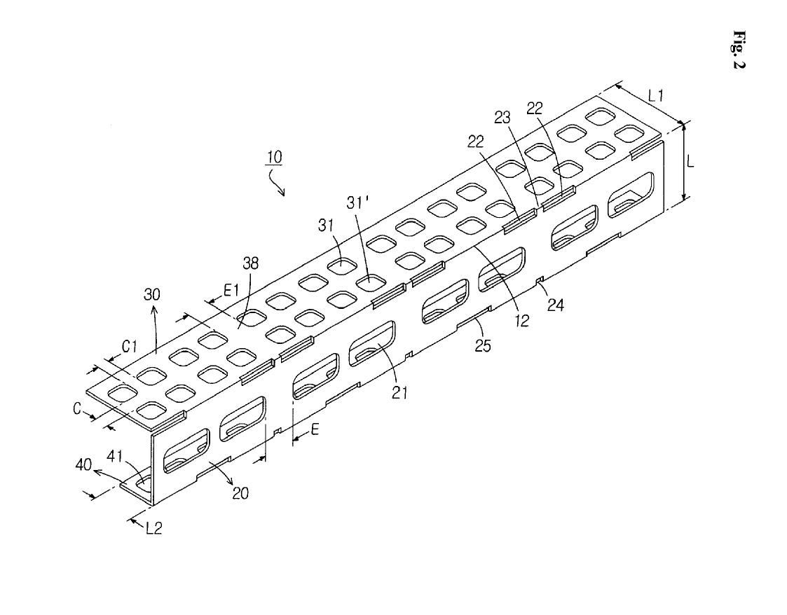

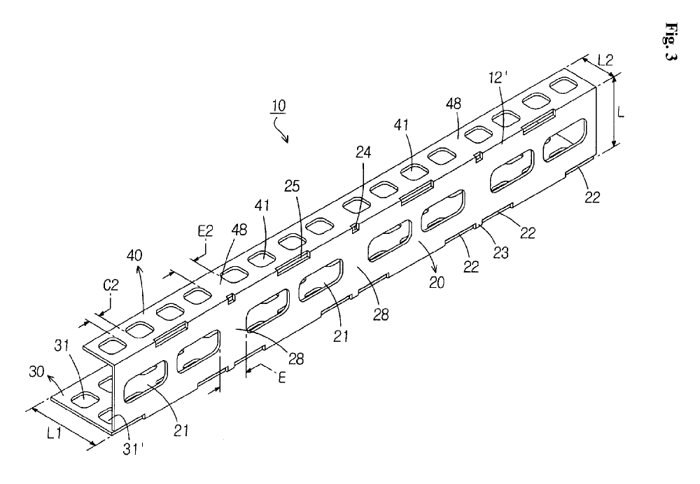

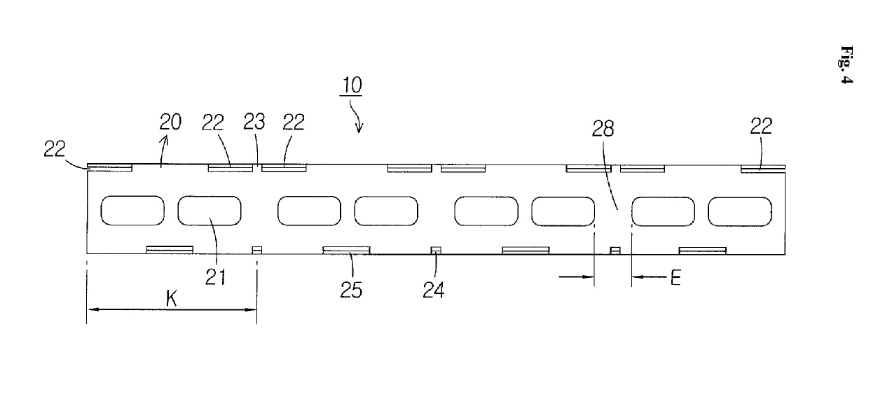

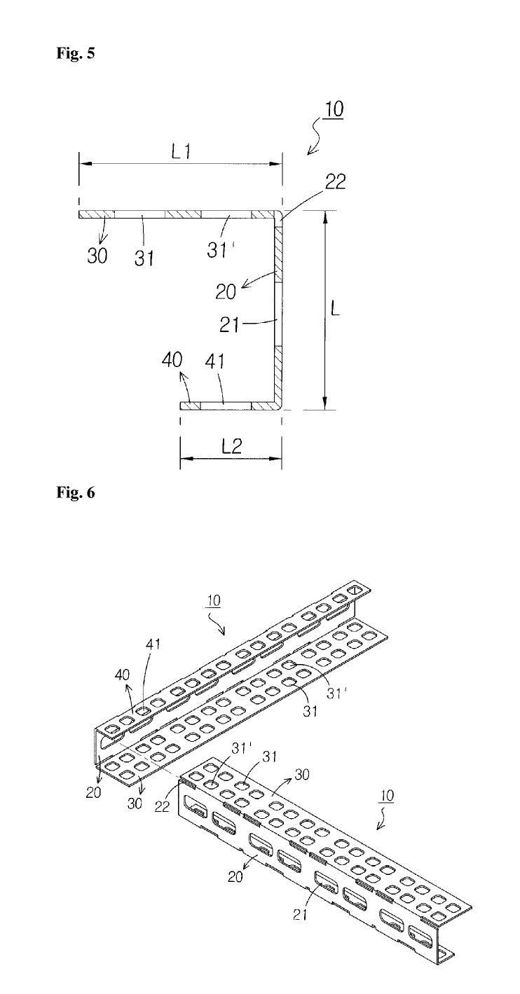

FIG. 1 is a development view of a channel 10 according to the present invention. FIGS. 2 and 3 are views of the channel 10, when seen from different directions. respectively, in which a wide-width supporting plate 30 and a small-width supporting plate 40 are configured to be bent at both sides on the basis of a central supporting plate 20.

In this case, a width L of the central supporting plate 20 and a width L1 of the wide-width supporting plate 30 are equal to each other, and a width L2 of the small-width supporting plate 40 is configured to be half the width L1 of the wide-width supporting plate 30.

Briefly describing a process of manufacturing the channel 10, a plurality of coupling holes and cutting portions are configured to be punched on a flat steel plate 11, and the channel 10 is manufactured by bending the steel plate stepwise by a roll forming machine. The channel 10 is cut at a desired length for use.

The configuration of the channel 10 will be described below in more detail.

Rectangular central surface coupling holes 21 configured to be slightly elongated on the central supporting plate 20 are punched at equal intervals, and wide-width surface coupling holes 31 and 31′ and small-width surface coupling holes 41 are punched at equal intervals on the wide-width supporting plate 30 and the small-width supporting plate 40 configured to be bent at a right angle at both ends of the central supporting plate 20.

The sizes of the wide-width surface coupling holes 31 and 31′ and the small-width surface coupling holes 41 punched on the wide-width supporting plate 30 and the small-width supporting plate 40, respectively, are configured to be equal to each other. However, the wide-width surface coupling holes 31 are configured in double rows on the wide-width supporting plate 30, and the small-width surface coupling holes 41 are configured in a single row on the small-width supporting plate 40. Also, the wide-width surface coupling holes 31′, which are punched inside the wide-width supporting plate 30, that is, toward the bent portion 12, are formed at the same locations as those of the small-width surface coupling holes 41 punched on the small-width supporting plate 40.

On the bent portion 12 located at one side of the central supporting plate 20 in the width direction, that is, toward the wide-width supporting plate 30, a pair of cutting portions 22 are formed at equal intervals. A cutting indicating portion 23 is configured between the cutting portions 22. One side of the cutting portion 22 is always opened, which is located on both ends of the channel 10 cut with a desired length by cutting the channel 10 with a cutting blade through the cutting indicating portion 23.

Furthermore, on the bent portion 12′ located at the other side of the center supporting plate 20 in the width direction, that is, toward the small-width supporting plate 40, rectangular indicating holes 24 and cutting holes 25 are configured at equal intervals. However, the rectangular indicating holes 24 are located with the cutting indicating portions 23 linearly side by side, and when cutting through the cutting indicating portion 23, the cutting of the channel 10 can be made at an exact location by cutting through the rectangular indicating hole 24 with the cutting blade.

In configuring the channel 10 according to the present invention, the central supporting plate 20, the wide-width supporting plate 30 and the small-width supporting plate 40 of the channel 10 have a configuration in which the coupling holes 21, 31, 31′ and 41, the cutting portions 22, the rectangular indicating holes 24, and the cutting hole 25 formed thereon are continuously repeated on the basis of a space K between the cutting indicating portion 23 and the cutting indicating portion 23 as shown in FIG. 1.

Furthermore, intervals C and C1 between the double rows of the wide-width surface coupling holes 31 and 31′ punched on the wide-width supporting plate 30 and intervals C2 between the small-width surface coupling holes 41 punched on the small-width supporting plate 40 are configured to be equal to each other, such that each of these coupling holes 31, 31′ and 41 may be exactly matched even if they are overlapped in an orthogonal direction in assembling of the channel 10.

Moreover, when cutting on the basis of the cutting indicating portion 23 and the rectangular indicating hole 24, a central surface extension portion 28, a wide-width surface extension portion 38, and a small-width surface extension portion 48 are configured among the central surface coupling holes 21, the wide-width surface coupling holes 31, and 31′ and the small-width surface coupling holes 41 located on the both sides of a cut portion, but intervals E, E1 and E2 between each of these extension portions 28, 38 and 48 are configured to be equal to each other.

The intervals E, E1 and E2 between the extension portions 28, 38 and 48 are configured to be wider than the intervals C, C1 and C2 between the wide-width surface coupling holes 31 and 31′ and the small-width surface coupling holes 41, such that when cutting on the basis of the cutting indicating portion 23 and the rectangular indicating hole 24, the coupling holes 21, 31, 31′ and 41 located on the both sides of the cut portion may not be in contact with the cut potion and may be maintained independently.

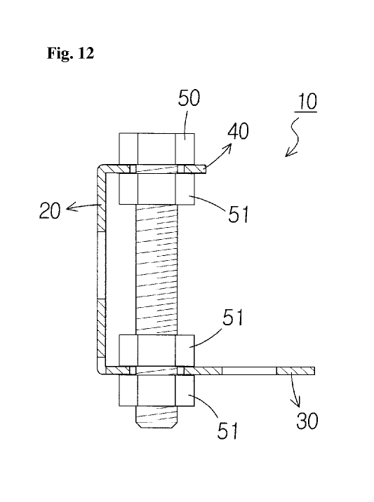

In order to prevent the deformation by an external force when using of the channel 10, as shown in FIG. 12, the small-width supporting plate 40 and wide-width supporting plate 38 are coupled by the reinforcing bolts 50 and the reinforcing nuts 51, such that the deformation of the channel 10 may be prevented.

The non-described reference numerals 60, 61, 62, 63, 64 and 65 are a supporting tool, a bolt, a nut, a clamp, a U-band, and a fixed subject, respectively.

The channel 10 configured as above does not differ from typical channels in that the supporting tools 60 are manufactured in various forms by using the channels 10, and these supporting tools are used to install the channels 10 in the ceilings or the walls of various architectural structures, or underground utility tunnels in which telecommunications facilities are installed, such that may be used for the support of various pipes or cables, or that may be used for the shelves to display machine equipment constructions or various goods.

However, in the channel 10 provided in the present invention, when attempting to assemble the supporting tool 60 with the use of the channels 10, firm and rapid assembly can be performed by using only the bolts and the nuts without the use of additional connective brackets for assembling of the connective parts of the channels.

The supporting tool 60 using the channels 10 is assembled as follows.

First, the channel 10 made to have a long length is cut to a desired length, and the cutting reference points to cut a channel 10 are cut on the basis of the cutting indicating portions 23 and the rectangular indicating holes 24 configured between the cutting portions 22 such that the channel 10 is cut straightly.

At this time, by cutting with the cutter blade, the cutting indicating portions 23 are cut and removed, such that one sides of the cut portions can maintain open states, as shown in FIGS. 2 and 3, and the channel 10 to be assembled is cut as many times as necessary in the same manner as above.

The assembly of the cut channels 10 is as follows.

That is, as shown in FIG. 6, when one channel 10 is located such that the small-width supporting plate 40 is placed on top and another channel 10 is located such that the wide-width supporting plate 30 is placed on top, the cutting portion 22 located on the bent portion 12 between the wide-width supporting plate 30 and the central supporting plate 20 is placed in the front of the small-width supporting plate 40 of the another channel 10.

In this case, when both sides of the channels 10 are assembled, the small-width supporting plate 40 located at the top of the one channel 10 is fitted into the cutting portion 22 configured on the bent portion 12 of the another channel 10, such that the wide-width supporting plate 30 and the small-width supporting plate 40 configured on each channel 10 are overlapped alternatively, and at the same time, the wide-width surface coupling holes 31 and 31′ punched in the double rows on the wide-width supporting plate 30 are matched side by side with the small-width surface coupling holes 31 and 31′ formed on the small-width supporting plate 40.

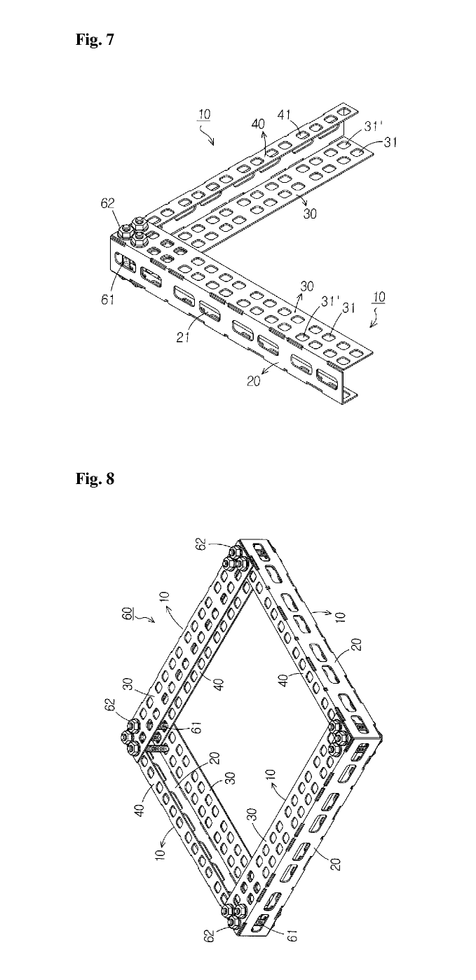

In this case, in the three coupling holes 31, 31′ and 41 located on a portion in which each channel 10 is overlapped, with the use of the bolts 61 and the nuts 62, they are coupled to be fixed, as shown in FIG. 7, and in the same manner as above, other channels 10 are assembled, a rectangular supporting tool 60 is configured to be assembled, as shown in FIG. 8.

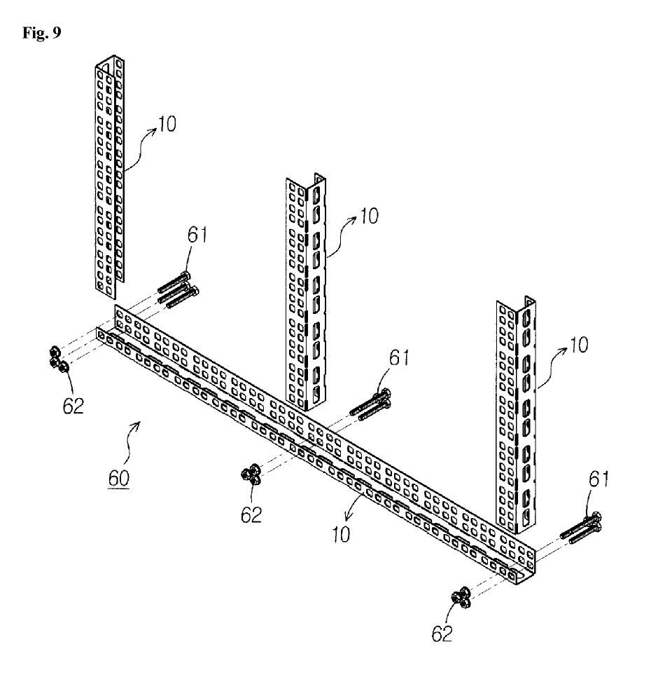

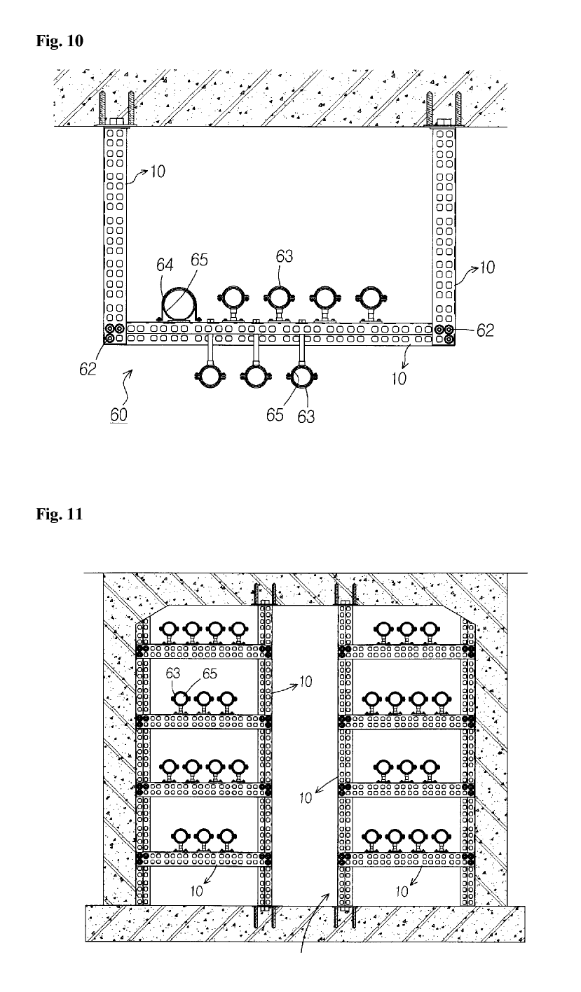

Various lengths of the channels 10 are assembled in the same manner as above, the supporting tool 60 such as in FIG. 9 is assembled, or the supporting tools 60 in the forms such as in FIGS. 10 and 11 are assembled for use.

Auxiliary binding devices, such as various clamps or U-bands, are simply bound using the wide-width surface coupling holes 31 and 31′, the small-width surface coupling holes 41, and the central surface coupling holes 21 configured on channel 10 in the state which the supporting tool 60 is assembled, and then fixed subjects, such as various pipes or cables, may be firmly bound.

In assembling the channel 10, the width L2 of the small-width supporting plate 40 configured on the one channel 10 is equal to the length of the cutting portion 22 configured on the end of the another channel 10. Therefore, when the small-width supporting plate 40 of the one channel 10 is fitted into the cutting portion 22 of the another channel 10, the wide-width surface and small-width surface coupling holes 31, 31′ and 41 configured on each channel 10 are matched with each other.

At this time, because the intervals C2 between the small-width surface coupling holes 41 punched on the small-width supporting plate 40 and the intervals C and C1 between the wide-width surface coupling holes 31 and 31′ punched on the wide-width supporting plate 30 in the double rows are matched with each other, the coupling holes 31, 31 ′ and 41 are exactly matched even though the channels to be assembled are assembled in an orthogonal direction.

Furthermore, the intervals E of central surface extension portions 28, and the intervals E1 and E2 of the wide-width and small-width surface extension portions 38 and 48 of the wide-width and small-width supporting plates 30 and 40 may be configured to be wider than the intervals C1 and C2 between the wide-width surface and small-width surface coupling holes 31, 31′ and 41. Therefore, even though the channel is cut on the basis of the cutting indicating portion 23 and the rectangular indicating hole 24, the central surface coupling holes 21 and the wide-width surface and small-width surface coupling holes 31, 31′ and 41 located at the both sides of cut portion do not encounter the cut portion.

In this present invention, the wide-width surface and small-width surface coupling holes 31, 31′ and 41 and the cutting portions 22 configured on the channel 10 are essential components for assembling, but the rectangular indicating hole 24 and the cutting hole 25 configured on the bent portion 12′ of the central supporting plate 20 and the small-width supporting plate 40 can assist to maintain balance when each of the coupling holes 21, 31, 31′ and 41 and the cutting portions 22 are punched with a press, such that efficient punching can be performed, and the stiffness can increase.

In using the channel 10, if the reinforcing bolt 50 is fitted into the wide-width and small-width supporting plates 30 and 40 and then they are supported by the reinforcement nut 51 as shown in FIG. 12, a phenomenon that the interval between the wide-width and small-width supporting plates 30 and 40 is broadened or narrowed can be prevented, thereby improving rigidity against an external force.

As described above, the channel according to the present invention is configured such that the coupling hole, the cutting portion, and the cutting hole are punched by the pressing work on the steel plate, and then the channel is bent in three layers by using the roll forming machine, and thus, the wide-width and small-width supporting plates on both sides of the central supporting plate are bent. However, the cutting portion are maintained in opened states on the both ends such that, in assembling the channel, when the small-width supporting plate of the another channel is fitted into the cutting portion of the one channel, the wide-width supporting plate and the small-width supporting plate of each channel are overlapped alternatively, and in this case, these are coupled to be fixed by the bolts and the nuts. Therefore, the desired form of the supporting tool is assembled such that the rapid, easy, and firm assembling can be expected. In particular, in assembling the supporting tool, the use of the additional connective bracket as in the typical channels is unnecessary. Therefore, cost reduction and ease of assembling can be expected.

1. An assembling channel of a supporting tool in which a steel plate on which a plurality of coupling holes are punched is configured to be bent in three layers, the channel comprising:
a wide-width supporting plate (30) and a small-width supporting plate (40) bent on both sides of a central supporting plate (20);
a pair of cutting portions (22) disposed at equal intervals on a bent portion (12) of the central supporting plate (20), and
a cutting indicating portion (23) disposed between the pair of the cutting portions (22),
wherein,
the channel (10) is cut on the basis of the cutting indicating portion (23) such that the cutting portions (22) located on a cut portion has one side opened;
a width (L1) of the wide-width supporting plate (30) configured to be bent at one side of the central supporting plate (20) is about two time wider than a width (L2) of the small-width supporting plate (40) configured to be bent at the other side of the central supporting plate (20);
the wide-width supporting plate (30) has wide-width surface coupling holes (31 and 31′) in double rows and the small-width supporting plate (40) has small-width surface coupling holes (41) in a single row; and
intervals (C and C1) between the wide-width surface coupling holes (31 and 31′) and an interval (C2) between the small-width surface coupling holes (41) are configured to be equal to each other such that the coupling holes (31, 31′ and 41) are configured to be aligned with each other during assembling of the channel (10).

2. The channel of claim 1, wherein the central supporting plate (20), the wide-width supporting plate (30), and the small-width supporting plate (40) constitute a central surface extension portion (28), a wide-width surface extension portion (38), and a small-width surface extension portion (48), respectively, and intervals (E, E1 and E2) of the extension portions (28, 38 and 48) are wider than the intervals (C and C1) between the wide-width surface coupling holes (31 and 31′).

3. The channel of claim 1, wherein the central supporting plate (20) has a central surface coupling holes (21) at equal interval, and rectangular indicating holes (24) and cutting holes (25) are alternatively configured on a bent portion (12′) between the central supporting plate (20) and the small-width supporting plate (40), the rectangular indicating hole (24) being aligned with the cutting indicating portion (23) on a parallel line.
